(19) United States
(12) Patent Application Publication
(10) Pub. No.: US 2024/0408793 A1
(43) Pub. Date: Dec. 12, 2024

(54) METHOD FOR MAKING REBAR ARRAYS

(71) Applicant: Laing O'Rourke PLC, Dartford (GB)

(72) Inventors: Hugh BOWERMAN, Woking (GB); Jason CALLEAR, Uttoxeter (GB)

(21) Appl. No.: 18/700,250

(22) PCT Filed: Sep. 30, 2022
(86) PCT No.: PCT/EP2022/077347

§ 371 Date: Apr. 10, 2024

(30) Foreign Application Priority Data
Oct. 12, 2021 (GB) 2114592.5

(51) Int. Cl. B28B 23/02; B21F 23/00

(52) U.S. Cl. CPC B28B 23/024; B21F 23/002

(57) ABSTRACT

Rebar, also referred to as reinforcing bar, is typically used to reinforce concrete to improve the tensile strength of elements made of concrete when constructing buildings, factories, bridges, nuclear power plants and other structures. There is a method of constructing an array (711) of rebars, the method comprising: automatically positioning a plurality of rebar such that they are spaced apart from one another to form an array (711); using an array interval spacing means (709) to maintain the spatial relationship of the rebar in the array; releasing the array from the array interval spacing means such that the array is placed in a target location and orientation for casting into concrete; and removing the array interval spacing means.

The present disclosure relates to construction of rebar arrays for use in reinforced concrete to strengthen and aid the concrete under tension.

### BACKGROUND

Rebar, also referred to as reinforcing bar, is typically used to reinforce concrete to improve the tensile strength of elements made of concrete when constructing buildings, factories, bridges, nuclear power plants and other structures. A variety of different materials are used to form rebar with the most common being carbon steel. Typically rebar has deformation patterns or ribs in the surface of the rebar to facilitate binding of rebar into concrete

Rebar is generally commercially available in a variety of fixed bar diameters and lengths. Thus rebar often has to be cut to particular lengths depending on construction requirements. Rebar is heavy and difficult to manoeuvre on a construction site since the rebar is long and unwieldy.

On a construction site rebar has to be placed and held in specified positions before casting into concrete. Concrete or plastic rebar spacers are often used to ensure the rebars are correctly positioned and held in place before and during casting of the concrete. Rebars are spot welded or tied using steel wire on the construction site. Mechanical couplers or splicers are sometimes used to connect rebars together although these are relatively difficult to use and incur cost. Another approach to rebar placement and fixing is to use roll reinforcement where a roll of material incorporating rebar is prepared off-site and then unrolled on site. However, roll reinforcement lacks versatility since the rebar must be parallel and, in the case of large diameter rebar where the rolls are difficult to unroll on site due to their weight, requires special equipment to do the unrolling on site. Also, where damage to the rolls occurs during transport there is a significant cost and time loss.

The examples described herein are not limited to examples which solve problems mentioned in this background section.

### SUMMARY

Examples of preferred aspects and embodiments of the invention are as set out in the accompanying independent and dependent claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to a first aspect of the disclosed technology there is a method of constructing an array of rebars, the method comprising:
automatically positioning a plurality of rebar such that they are spaced apart from one another to form an array;
using an array interval spacing means to maintain the spatial relationship of the rebar in the array;
releasing the array from the array interval spacing means such that the array is placed in a target location and orientation for casting into concrete;
removing the array interval spacing means.

In this way an efficient and effective method of constructing an array of rebars is given. Where the method is performed on a construction site it is not necessary to transport rebar arrays to the construction site which is a significant benefit where transport costs are high and where access to the construction site is restricted. In situations where the rebar arrays are particularly large in size and/or particularly dense, such as for the construction of nuclear power plants, it is beneficial to construct the rebar arrays on site. Other approaches where rebar arrays are constructed off site and then transported to construction sites are found to be impractical in the case of heavy civil engineering infrastructure including but not limited to the construction of nuclear power plants due to the weight and size of the rebar arrays. In the embodiments described herein the rebars in an array are not welded together or held in the array form using welding or tie wires. Alternative roll mat approaches rely upon connectors between rebar in an array to function. The inventors of the present technology have recognized that the connectors in roll matt arrangements add material to the arrangement resulting in higher cost, higher embodied carbon dioxide and mass.

In a preferred embodiment the array interval spacing means is a rotary cassette. Using a rotary cassette provides an efficient and effective way to hold individual rebar such that they are spaced apart from one another to form an array. In an example the rotary cassette is cylindrical and individual rebar are held in channels running longitudinally along a length of the cylinder and spaced apart around a diameter of the cylinder. To release the array from the rotary cassette individual ones of the rebar are dispensed from the rotary cassette as the rotary cassette rotates about a longitudinal axis of the rotary cassette as described in more detail below.

In a preferred embodiment the array interval spacing means is a bar cassette. A bar cassette provides an efficient and effective way to hold individual rebar such that they are spaced apart from one another to form an array. In an example the bar cassette is a bar having individual rebar holders which are generally V shaped holders spaced at intervals along the bar according to a desired array interval spacing. In an example more than one bar cassette is used, one holding first ends of individual rebar and another holding second ends of individual rebar.

In another preferred embodiment the array interval spacing means comprises a plurality of clamps spaced at intervals on a lifting frame. Each clamp is sized and shaped to receive and clamp a diameter of an individual rebar. In an example the clamps are operable by remote control. Using clamps on a lifting frame is found to be an efficient and practical way of maintaining the spatial relationship of the rebar in the array. Since the clamps are on a lifting frame it is straightforward to lift the frame, clamps and individual rebar using a lifting apparatus such as a crane.

Preferably the method further comprises: using a splitting apparatus to automatically split a single rebar from a bundle of rebars; using automated moving means to move and position the single rebar into a location in the array; and repeating the use of the splitting apparatus and automated moving means for each rebar of the array. In this way an automated method of constructing arrays of rebar is achieved which is operable on a construction site. Splitting a single rebar from a bundle of rebars is not straightforward since the rebar are long, heavy and difficult to handle. The risk to safety of construction site workers is high due to the abrasive nature of the rebar and the risk of impalement. As one rebar is picked from a bundle the remaining rebar in the bundle tend to roll and move under gravity and against one another making it difficult to control the picking of the individual rebar. The rebar have considerable momentum and are unwieldy due to their size, shape and weight. The task of splitting a single rebar from a bundle of rebars on a construction site is typically done manually and is time consuming and error prone. The problems are exacerbated for extremely long and heavy rebar such as those used for constructing nuclear power plants. Thus, use of a splitting apparatus and automated moving means gives considerable benefits in terms of safety, time saving and improved quality of rebar arrays.

Preferably the automated moving means is any one or more of: a conveyor belt, a cassette loader. Conveyor belts and cassette loaders are efficient and effective apparatus for automated moving of rebar on construction sites since these types of apparatus are practical to transport to a construction site and are robust as explained in more detail below. Conveyor belts and cassette loaders are able to move more than one rebar at a time which gives efficiency. The automated moving means is used for local automated moving during assembly of the array. In contrast moving rebar or rebar arrays more substantial distances on a construction site is done using a crane. Crane efficiency is improved by using the automated moving means (which is not a crane) for local moving.

In various examples the splitting apparatus is a hopper and a means for lifting a base of the hopper in order to tip one of a plurality of rebar in the hopper over an edge of the hopper. This is a practical and reliable way to automatically split individual rebar from a bundle of rebar.

In various examples the splitting apparatus has a rotary receiver to receive the rebar which tips over the edge of the hopper. Using a rotary receiver gives control over the placement of the rebar which has been split from the bundle of rebar.

In various examples the method comprises receiving the plurality of rebar into one or more receivers, each receiver configured to hold a plurality of rebar. Using a plurality of receivers is beneficial where there are different diameters and/or lengths of rebar to be used since individual receivers are usable to segregate rebar according to diameter and/or length.

In some preferred embodiments the method comprises engaging the array interval spacing means with a lifting apparatus and using the lifting apparatus to move the array and the array interval spacing means to the target position and orientation. By using a lifting apparatus such as a crane the array and array interval spacing means are conveniently moved and positioned. Since the array interval spacing means is lifted together with the array the risk of damage to the array during movement is reduced.

In an example the method comprises activating holding means to hold the array in the target position and orientation; and releasing the array from the lifting apparatus. In this way the array is efficiently and carefully located in an automated manner on the construction site.

In an example, the automated moving means is a cassette loader and the cassette is a rotary cassette, and a bar riser is used to raise individual ones of the rebar towards a bar harvest mechanism which fills individual bars into the rotary cassette. In the example, the method comprises placing the rotary cassette onto a pair of drive bogies on pre-positioned rails and driving the bogies along the rails via remote control and using a remote control mechanism to release individual rebar from the cassette at intervals as the cassette is driven along the rails by the drive bogies. Using pre-positioned rails gives fine control over rebar placement using the remote control mechanism. The combination of a cassette loader, rotary cassette, bar riser and bar harvest mechanism is found to be practical and effective. In an example, the cassette is configured to only release a rebar which is in a bottom dead centre of the cassette so that placement of the released rebar is controlled.

In various examples where a bar cassette is used, the bar cassette comprises a plurality of hooks, each hook sized and shaped to hold a rebar, and where the hooks are rotatable between a first position in which rebar are held in the hooks and a second position where rebar roll out of the hooks and come to rest against an immediately preceding hook of the bar cassette. This is an effective way to automatically form a rebar array since the hooks are used to hold rebar and also as stops to prevent rolling of released rebar.

In an example where hooks are used on a bar cassette, the method may comprise filling the hooks with rebar and lifting the bar cassette using an overhead crane and moving the bar cassette to the target position and orientation, and using a remote control to release the hooks to the second position. This gives an effective, controlled, automated way to form rebar arrays.

In a preferred embodiment there is a single apparatus having a splitting apparatus, array interval spacing means and automated moving means. By integrating the splitting, array interval spacing and automated moving means into a single apparatus it is possible to have a single unit that is transported to the construction site easily and which can be lifted and moved using a single crane or other lifting apparatus.

In various examples, the automated moving means is a conveyor belt having a deep pile surface configured to hold individual rebar in a fixed position. Using a deep pile surface gives the benefit that rebar do not roll when dispensed onto the deep pile surface and yet are easily picked up using automated moving means.

In some examples there are a plurality of receivers, each receiver for a different type of rebar, and the automated moving means comprises a first conveyor belt for conveying individual rebar from the plurality of receivers to a release gate which releases individual rebar onto a second conveyor belt such that the space between individual rebar on the second conveyor belt is controlled.

In various embodiments where clamps are used the clamps are configured to not project below the underside of a rebar. This prevents damage to rebar by the clamps.

In various embodiments where clamps are used the clamps are movable across the width of a lifting frame in order to align with rebars on a deep pile surface. Having movable clamps enables fine grained control of the interval spacing between rebar when forming an array. In some cases a bumper is used to generally align the frame over the deep pile surface and then a dowel is used to finely align the frame over the deep pile surface. Using a two stage alignment process gives improved quality and accuracy of frame alignment and thus array placement.

In some examples the method comprises checking individual ones of the rebar for straightness using a mechanical and/or image processing procedure. In this way quality of the rebar arrays is improved.

In some examples the splitting apparatus and an array layout bed are movable with respect to one another. By enabling relative movement between these two items it is possible to more efficiently and effectively construct rebar arrays.

In various examples, prior to releasing the array from the array interval spacing means, the method comprises moving the array interval spacing means and the array to the target location. In this way the array can be constructed at a different location on the construction site from the location where it will be cast into concrete.

It will also be apparent to anyone of ordinary skill in the art, that some of the preferred features indicated above as preferable in the context of one of the aspects of the disclosed technology indicated may replace one or more preferred features of other ones of the preferred aspects of the disclosed technology. Such apparent combinations are not explicitly listed above under each such possible additional aspect for the sake of conciseness.

Other examples will become apparent from the following detailed description, which, when taken in conjunction with the drawings, illustrate by way of example the principles of the disclosed technology.

### BRIEF DESCRIPTION OF THE DRAWINGS

FIG. 1 shows examples of arrays of rebar;

FIG. 1A is a flow diagram of a method of automatically constructing a rebar array;

FIG. 1B is a flow diagram of a method of forming and positioning a rebar array;

FIG. 2 shows using a splitter to load rebar into a harvester and subsequently rolling out the rebar to form an array;

FIG. 3 shows using a splitter to load rebar into a liftable rotary cassette and subsequently dispensing rebar from the cassette to form an array;

FIG. 4 shows a bundle splitter;

FIG. 5 shows a bar cassette used to carry and release rebars;

FIG. 5A shows a combined bundle splitter and cassette;

FIG. 6 shows a lifting frame with clamps used to place an array of rebar onto a deep pile surface.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

Various examples of constructing rebar arrays are described for use on construction sites. It is recognized that rebar array and cage construction may be done in a factory with the resulting rebar arrays and cages having to be transported to the construction site from the factory. However, the present technology is concerned with situations where rebar arrays are constructed on a construction site where the rebar arrays are intended to be cast into concrete. There are various situations where it is not practical to transport pre-formed rebar arrays and cages to a construction site, such as where access is constricted or where the size and shape of rebar arrays/cages makes transportation impractical.

As explained above rebar is heavy and unwieldy making it difficult to transport and manoeuvre. To form arrays of rebar in order to reinforce concrete is time consuming, error prone and costly. Rebar is typically provided from manufacturers in bundles with each bundle containing the same diameter and length of rebar. Many bundles have to be transported to the construction site especially where several different lengths and different diameters of rebar are to be used. It is then necessary to pick individual rebar from different ones of the bundles according to a required length and diameter. In normal practice, where rebars are greater than about 20 millimetres in diameter, the bundle of rebars is moved to the site location and individual rebars are separated from the bundle manually. An array is formed as each individual bar is manually positioned and fixed in a final location before being cast into concrete.

Where the rebar is longer than typical and/or where rebar arrays are denser than typical, such as in construction of nuclear power plants, the problems of rebar array construction and use are exacerbated.

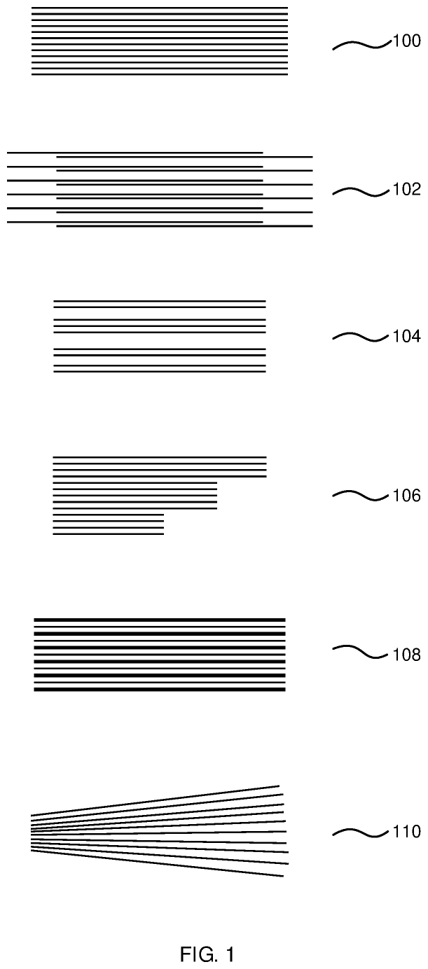

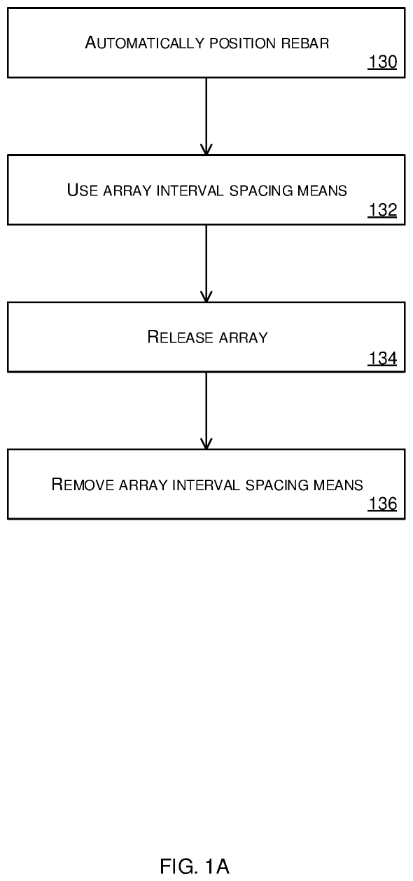

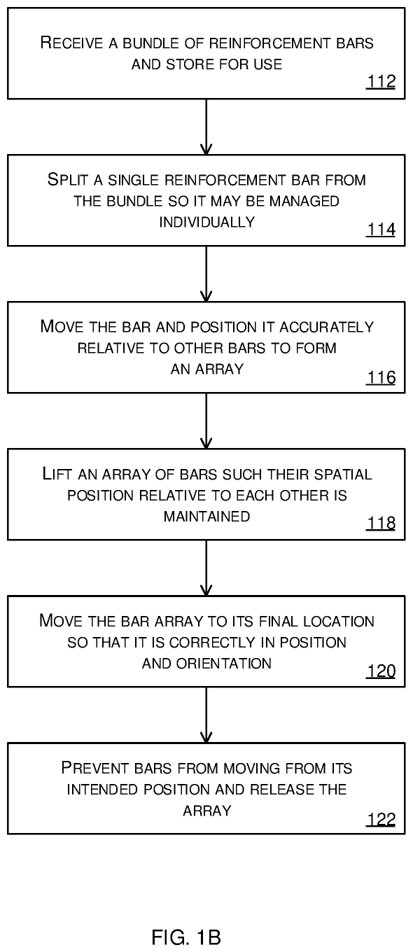

The term “rebar array” is used to refer to a plurality of reinforcing bars arranged in a generally flat, planar form so that the bars are generally parallel and spaced from one another by intervals so that the individual bars do not cross over one another. An array consists of bars in the same plane, spaced at intervals and running in approximately the same direction. The bars may be of the same or different length, may be of the same or different diameter and the intervals between the bars may be the same size or different sizes. Generally the rebars in an array are not welded together or held in the array form using welding or tie wires. A non-exhaustive list of examples of rebar array is now given with reference to FIG. 1.

FIG. 1 shows a plain rebar array 100 where the plurality of rebar are of the same length and diameter and are arranged parallel to one another supported by a generally planar surface, and spaced from one another by generally equally sized intervals. In the case of the plain rebar array the rebar are aligned with respect to each other so that the ends of the rebar are aligned. same diameters same length bars at identical pitch. The array sits within a rectangular perimeter. Plain arrays make up the vast majority in use. In various embodiments described later in this document one or more receivers are used to receive rebars and in some cases there are several receivers, one per different combination of length and diameter of rebar to be used in constructing a rebar array. In the case of plain arrays only one receiver is required.

FIG. 1 also shows a staggered rebar array 102 which is the same as the plain rebar array 100 except that alternate ones of the rebar are shifted so that ends of even ones of the rebar are aligned and so that ends of odd ones of the rebar are aligned. Similar to a plain array except that bars can be staggered relative to each other. Only a single receiver is required.

FIG. 1 shows a variable pitch rebar array 104 which is the same as the plain rebar array 100 except that the intervals between the rebar vary in size. The spacing between bars can be changed. If bars are all of the same diameter and length, only one receiver is required

FIG. 1 shows a different length rebar array 106 which is the same as the plain rebar array 100 except the individual ones of the rebar in the array are of one of three different lengths. Bars within a single array have different lengths. Note that there would normally be a limited number of length differences within a given array, as illustrated. In this case the number of receivers required corresponds to the number of bar lengths. Where an infinite length variation is required, either single or multiple receivers are used with the additional process of cutting to length at the splitting stage of the process.

FIG. 1 shows a different diameter rebar array 108 which is the same as the plain rebar array 100 except individual ones of the rebar are of different diameter. Bars within an array have different diameters. Note that it is unusual to have more than two diameters in a single array. When constructing a different diameter rebar array 108 a separate receiver is used for each different diameter of bar.

FIG. 1 shows a radial rebar array 110 which is the same as the plain rebar array 100 except that first ends of the rebar are closer together than second ends of the rebar to form a fan shape. Bars are positioned to form a radial pattern. Bars may be held in place using bar locators which are described in more detail below. The angle of arc possible is limited by the minimum and maximum spacing possibilities of the bar locators.

FIG. 1A is a flow diagram of an example method of constructing a rebar array which is suitable for performing on a construction site. The method is particularly suitable for speeding up construction of arrays of heavy rebar, such as where the rebar is 25 millimetres in diameter or greater. However, the method is applicable for rebar of any length or diameter including where rebar is 40 millimetres in diameter or greater such as for nuclear power plant construction.

The method comprises automatically positioning 130 a plurality of rebar such that they are spaced apart from one another to form an array, using 132 an array interval spacing means to maintain the spatial relationship of the rebar in the array, releasing 134 the array from the array interval spacing means such that the array is placed in a target location and orientation for casting into concrete, and removing 136 the array interval spacing means. The array is then cast into concrete.

Because the array interval spacing means is removed before the array is cast into concrete there are cost and carbon dioxide savings as compared with roll mat approaches. The array interval spacing means is re-usable giving further savings of cost and carbon dioxide.

As explained in more detail below, the array interval spacing means is implemented in a variety of possible forms and a non-exhaustive list of examples is: rotary cassette, bar cassette, clamps spaced at intervals on a lifting frame. The array interval spacing means is thus compact and easily transported to a construction site. The array interval spacing means, in some examples, also provides a means for carrying the array so that the array is liftable using a crane or other apparatus on the construction site.

The method of FIG. 1A is particularly suitable for constructing rebar arrays where the weight of the rebar array is greater than for construction of a domestic building.

FIG. 1B is another example of a method of constructing a rebar array which is also suitable for performing on a construction site. The method comprises receiving 112 a bundle of reinforcement bars and storing them for use and automatically splitting 114 a single reinforcement bar from the bundle so it may be managed individually.

The method continues with automatically moving 116 the bar and positioning it accurately relative to other bars to form an array.

The method involves lifting 118 the array of bars such their spatial position relative to each other is maintained; and moving 120 the array to a final location so that it is correctly in position and orientation. The method involves preventing 122 the bars from moving from their intended position and releasing the array. The array is then in position and is cast into concrete.

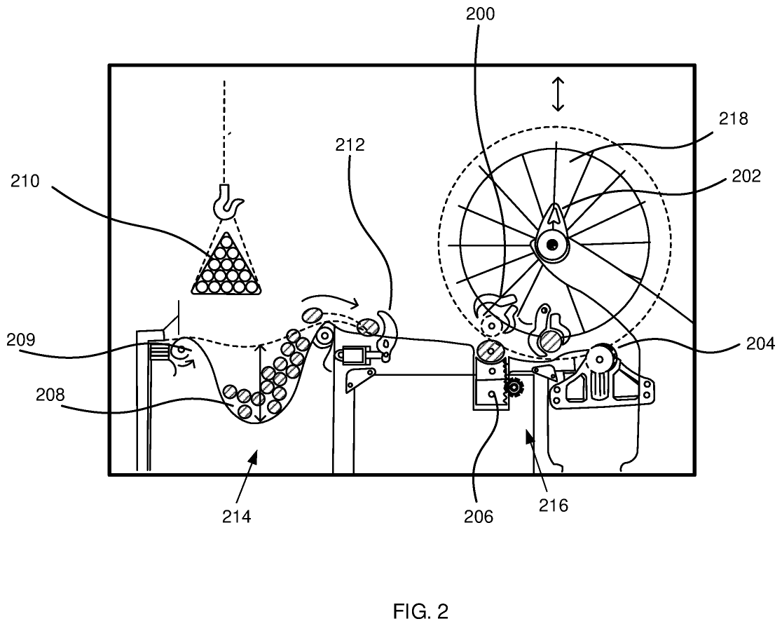

FIG. 2 shows a plurality of rebar 210 being lifted using a crane (not shown) into a receiver which in this case is a hopper 208 formed from flexible material. Means for lifting the base of the hopper 208 is provided so that the depth of the hopper (as indicated by the double headed arrow in FIG. 2) can be reduced. In the example of FIG. 2 the means for lifting the base of the hopper 208 is a rotatable bar around which one edge of the flexible material is wound. As the bar rotates to wind up more of the flexible material the base of the hopper rises. As the base of the hopper rises, rebar in the hopper rise until an uppermost rebar rolls over a lip of the hopper and comes to rest against a release gate 212.

The hopper 208, rotatable bar 209 and release gate 212 together form a splitting apparatus 214.

FIG. 2 shows using a splitting apparatus 214 to load rebar 210 into an array interval spacing means which in this example is a rotary cassette 218. The rotary cassette 218 is generally cylindrical and FIG. 2 shows one end of the rotary cassette. The rotary cassette has recesses for holding individual rebar around a perimeter of the cylinder. The rotary cassette rotates about an axel and lifting mechanism 202 is operable to lift the cylinder from a first position illustrated in FIG. 2 to a second position where the cylinder comes away from the axel. The double headed arrow above the cylinder in FIG. 2 is intended to indicate the movement between the two positions.

The rotary cassette is part of a harvester 216 which operates to load rebar into the rotary cassette 214. The harvester has one or more grippers 200 which grip individual rebar and insert the individual rebar into the rotary cassette as indicated. The release gate 212 opens to allow an individual rebar to roll down a platform into a bar riser 206 which inserts the individual rebar into a gripper 200. Motor 204 rotates the rotary cassette.

In the arrangement of FIG. 2, instead of being released onto a movable table, a rebar array is collected around the perimeter of the rotary cassette 214 equipped to hold the bars. The loaded rotary cassette 214, is taken to an adjacent area of the construction site where the array is discharged and a separate lifting device used to move the array to a target location where the rebar array is cast into concrete. Alternatively, the rotary cassette, filled with rebar, is lifted to the target location and the array discharged in-situ.

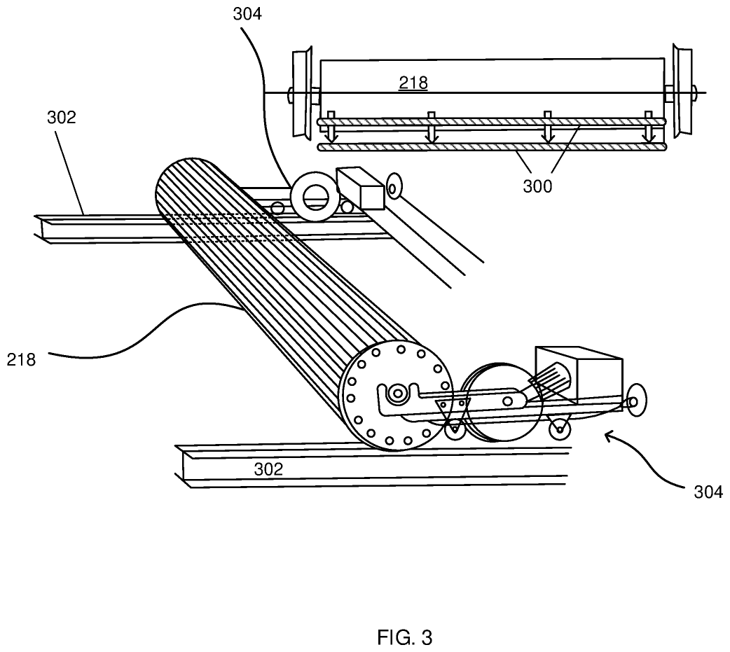

FIG. 3 top right shows unloading individual rebar 300 from a liftable rotary cassette 218 and subsequently placing the loaded rotary cassette onto rails 302 in order to dispense rebar from the rotary cassette 218 to form an array. Drive bogies 304 are used to drive the rotary cassette along the rails and rotate the rotary cassette 218. A remote control mechanism is used to release individual rebar from the rotary cassette so that rebar are placed at specified intervals between the rails 302. Note that in FIG. 3 the rotary cassette 218 both forms the array interval spacing means and acts as a lifting frame to enable the array to be moved to a target location.

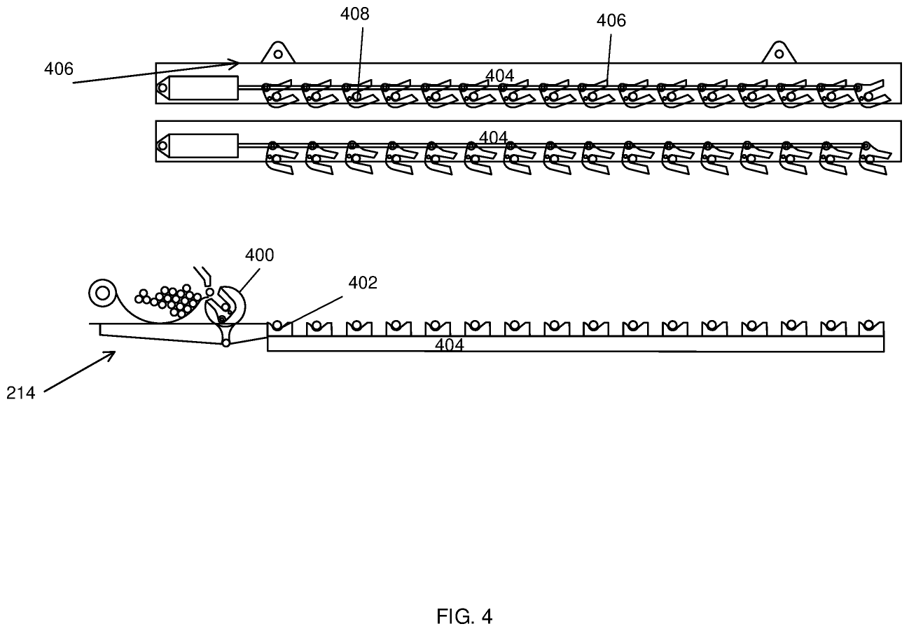

FIG. 4 shows a splitting apparatus 214 comprising a hopper similar to that of FIG. 2 and a rotatable receiver 400 which has a mouth to receive one rebar and which is rotatable between a first position where the mouth holds the rebar and a second position where the rebar rolls out of the mouth onto a V shaped holder 402. There are a plurality of V shaped holders 402 spaced at intervals on a bar cassette 404. The bar cassette 404 is an example of an array interval spacing means.

The top part of FIG. 4 shows another bar cassette 404 which is integral with a lifting frame 410 to enable the bar cassette to be lifted by a crane and moved to a target location. The bar cassette 404 has a plurality of hooks 406 each holding a rebar 408. The hooks are rotatable between a first position (top part of FIG. 4) where the hooks 406 hold rebar 408 and a second position (middle part of FIG. 4) where rebar are able to roll out of the hooks. In the middle part of FIG. 4 the rebar are about to roll out of the hooks.

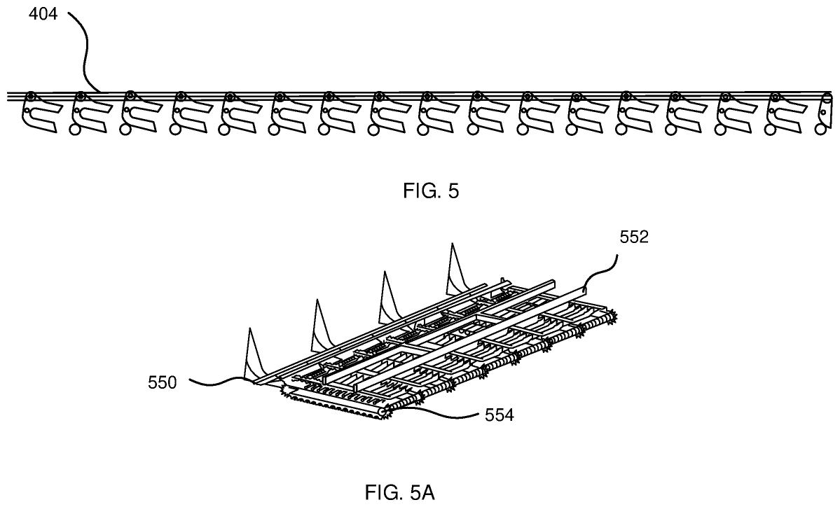

FIG. 5 shows a bar cassette 404 used to carry and release rebars. FIG. 5 shows the situation where the hooks 406 of the bar cassette 404 are in the second position and the rebar 408 have rolled out and come to rest against the immediately preceding hook of the bar cassette. In this way the hooks 406 are used to ensure accurate placement of the rebar when the rebar are released from the array interval spacing means (i.e. the bar cassette in this example).

FIG. 5A shows a combined splitting apparatus 214 and array interval spacing means. In this case the splitting apparatus 214 comprises a plurality of hoppers 550 attached to the side of a cassette 554 which is a frame for holding rebars. The frame has struts 552 which are used for attaching to a lifting apparatus in order to lift and move the cassette 554. Maintenance of level of the cassette 554 is controlled as the centre of gravity of the cassette 554 changes according to how many rebar are loaded into the cassette.

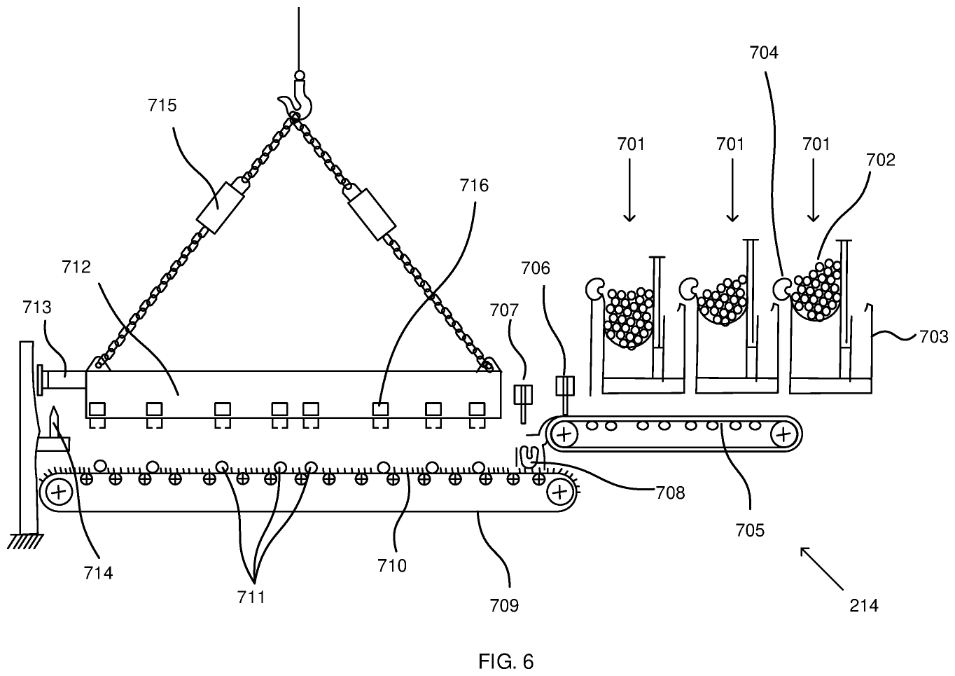

FIG. 6 shows a lifting frame 712 with clamps 716 used to place an array of rebar 711 onto a deep pile surface 710 which is on a conveyor.

FIG. 6 shows a schematic of a solution that handles different length or diameter bars. There are three receivers 701. Each receiver 701 contains a bar bundle 702. Each receiver 701 incorporates a linear actuator 703. Raising a linear actuator 703 raises the bundle of bars 702 until one bar rolls into a slot in a slotted camwheel 704. Different diameter bars are used with different slotted cam wheels 704.

To release a bar, a slotted cam wheel 704 is rotated 90 degrees. The rebar drops onto conveyor 705. Conveyor 705 carries the bar to a gate 706. By releasing bars in the correct sequence, complex arrays are put together,

When required, bars are released to pass gate 706. They are stopped at gate 707. At this stage bars are checked for straightness and positioned longitudinally. They are then released by gate 707 and held in slotted cam 708. The slotted cams 708 are designed to release the bars accurately onto the array assembly conveyor 709. This is covered in a long pile matting 710 such that bars do not roll substantially but stay where dropped. By indexing the conveyor 709 and co-ordinating with the release by slotted cam 708, complex arrays can be built up. Where radial capability is required, an additional axis of control is applied to the slotted cam 708 assembly such that bars are released at a small angle.

As conveyor 709 moves forward, array 711 is formed. It will be apparent that bar spacing can vary infinitely.

Once an array has been created, lifting frame 712 is positioned over the deep pile surface. Bumper 713 acts as rough guidance to ensure alignment of the lifting frame 712 and deep pile surface 710. Dowel 714 provides fine guidance. In order that the lifting frame 712 is level, manual or automatic adjustment is made by chain length adjusters 715.

The lifting frame 712 is equipped with clamps 716. These are located so that in plan they are between conveyors 709. The clamps 716 are moveable to any location across the width of the lifting frame 712 so that they align with the bar in the array 711. To prevent interference when releasing bars, the clamps 716 do not project below the underside of a bar in operation, when a clamp is clamping a bar.

Lifting frame 712 is lowered to pick up the complete array 711 from the deep pile surface 710. Once clamps 716 are activated, the array is moved to its desired location where the bars are released.

More detail about various of the steps of the methods of FIGS. 1A and 1B is now given.

Rebar are received 112 (FIG. 1B) such as by being unloaded from a vehicle using a crane and stored for later use. The received rebar are in bundles as explained above, and there are different bundles for different combinations of length and diameter of rebar where desired. In some cases the rebar are stored in receivers such as hoppers with different hoppers for different combinations of length and diameter of rebar. The receivers or means for storing the rebar are carefully selected and designed as it influences automation of later steps of the method. FIG. 6 shows three receivers 701.

Rebars are classically delivered in same length, same bar diameter bundles. The bundles are usually steel strapped. The bundles are typically transported on the back of a flat bed trailer. Bars may be of any diameter or length, and in preferred embodiments of the present invention bars are between 20 millimetres (mm) and 40 mm in diameter and 8 metres (m) and 14 m in length.

Bar bundles are lifted from the flat bed trailer into a receiver which is used with a splitting apparatus 214 (as described in more detail below). Lifting is done by lorry mounted crane, an overhead crane or a davit system attached to the splitting apparatus 214. Any steel strapping is removed.

Where rebar arrays of same length, same diameter bars are to be constructed there is a single receiver 701. Where rebar arrays comprising multiple lengths and/or multiple diameters are to be made there are multiple receivers 701.

An individual rebar is split 114 from a bundle so that it can be managed individually. It is not straightforward to split 114 a rebar from a bundle due to the heavy weight and unwieldy nature of the rebar 210. Various automated mechanisms are described below for splitting 114 individual rebar from a bundle. As compared with manual processes for splitting rebar these automated mechanisms are efficient and improve the overall safely of the process as well as the quality of the resulting rebar array.

In an example, a single bar is split from a bundle by raising the whole bundle up inside the receiver until one or more bars rolls off and down an inclined surface where it will rest against a release gate 212. Opening the release gate 212 allows one bar to be released into a conveyor pre-load area.

In another example, the splitting apparatus 214 is a hopper and a means for lifting a base of the hopper in order to tip one of a plurality of rebar in the hopper over an edge of the hopper. In an example the hopper is a flexible sling as illustrated in FIG. 2 and FIG. 6. A check is made for bar straightness. If a bar has become bent during transport, it is rejected and removed from the process. In an example, the straightness check involves using a camera mounted on the splitting apparatus to capture images of an individual rebar split from the bundle. The image is processed using image processing software, either at the construction site or in the cloud, to check for bar straightness. In an example the software carries out edge detection and template matching and using one or more rules or thresholds makes an automated decision regarding bar straightness.

In some examples the check for bar straightness is mechanical. For example, if an individual rebar split from the array is unable to fit into bar interval spacing means it is rejected as not being straight and removed from the process. Combinations of mechanical and image processing straightness checks are used in some cases.

In various examples, the method comprises positioning an individual rebar to a specified longitudinal position. This is achieved by applying a longitudinal force to move the bar, typically by a pushing device. The bar moves until it hits an adjustable stop. The stop position is manually or automatically changed.

In some configurations of the process (e.g., regular arrays, one sized bar only), a pre-load area exists as an area ahead of a gate. In the examples of FIG. 2 and FIG. 6 which are explained in more detail later in this document there is a pre-load area.

In some embodiments, the splitting stage may involve the additional process of cutting a bar to length. Where bars are cut to length it is possible to create arrays with bars of any length variation. That is, there is potentially infinite length variation.

Once an individual rebar has been split 114 from a bundle it is moved 116 and positioned accurately relative to other rebars in order to form an array. As illustrated with reference to FIG. 1 the spaces between the rebar and the way the rebar are positioned with respect to one another is very important for accurate rebar array construction.

The steps of splitting 114 and moving 116 and positioning are repeated for more individual rebar until there are the desired number of rebar in the array.

In some cases, the more complex arrays are made by placing two simple arrays over the top of each other. For example, the ‘different diameter’ array 108 which requires a machine with two or more receivers is made by placing one single diameter bar array but with wider pitches and then placing a second, also wider pitched array over the top of it such that the bars nest between each other. In this way single receiver machines are used to make the more complex arrays. It will be apparent that a great variety of array types can be made in this manner.

In the example of FIG. 2 and FIG. 6 bars exiting from the release gate 212 are held to prevent them rolling out of position. To prevent rolling, strips of long pile matting may be used as described in more detail with reference to FIG. 6. The stiffness of the pile is selected so that a bar may nest down under self-weight. Pile resilience is such that the weight of a rebar does not damage fibres of the pile, resulting over time in the matting becoming too flat to prevent rolling.

An alternative method of securing the bars in the correct position is to provide one or more upward facing V shaped holders as illustrated in FIG. 4. In FIG. 4 the holders are in the form of a comb. The comb has V's to match the positions of the bars. The comb may have positions at, say, 50 mm pitch. This single comb is then used to create arrays with pitches going up in 50 mm increments. Variation in pitch is possible, so long as it is a multiple of 50 mm, e.g., 100-150-200-150-100. Different combs are used for different multiples of pitch. Bespoke comb sets are used for radial arrays or other types of arrays.

In various examples there is a release gate 212 which opens to allow a bar to drop under gravity. In order to create an array, the next bar is to drop into a different location. This requires a splitter release gate 212 and an array layout bed to be able to move relative to each other. There are a number of solutions as now described.

In an example, matting or combs for holding individual rebar are mounted on a conveyor (such as 709 of FIG. 6) which forms an array layout bed. As the conveyor moves a relative position between the splitting apparatus 214 and a point on the conveyor changes. Note that with combs the predetermined comb pitch defines discrete intervals of relative position change between the splitting apparatus 214 and array layout bed (e.g. deep pile surface 710). With long pile matting there is continuous change in relative position between the splitting apparatus 214 and the array layout bed since a bar may be dropped anywhere on the array layout bed. Note that separate V's can also be mounted on a conveyor, allowing them to wrap under and reduce the conveyor length.

In various example, a robot picks the bar up from the release gate 212 output, moves it to the correct location and releases it. The robot is an autonomous mobile robot of any suitable type.

In some example where a robot is used to position the bar, then the same robot is used to lift the bar directly from a receiver 701, thus serving the function of the gate as well.

The array of rebars is then lifted 118, using a crane or other lifting apparatus, in such a manner that the spatial arrangement of the individual bars in the array is maintained. Since the rebars are heavy and lengthy it is difficult to carry out the lifting whilst also maintaining the spatial arrangement. Various means for achieving this are described herein.

The bar array is lifted such that the relative spatial positions of the rebars is accurately maintained (longitudinal and transverse). This is achieved using a lifting frame 410, 712. The complexity of this frame depends on the complexity of the array, and comprises one or more of the following features:

A frame that is substantially 2D, but has sufficient 3rd direction dimension to ensure the frame has limited torsional deflection should it be unevenly loaded.

Two or more rows of remote operable clamps 716 that can clamp a bar to enable it to be lifted from an array layout bed.

A means of adjusting the distance between the clamps 716 such that they match the spacing of the array of bars on the array layout bed.

A means of adjusting chain lengths attaching the lifting frame to a crane hook or hooks such that the lifting frame is level

In an example of a clamp 716, the clamp 716 is default closed and energised to open, e.g. using pneumatics. The clamp jaw 716 is arranged so that it does not project below the underside of the bar. This enables the clamp positions to operate independently of any pre-placed steel or support chairs.

In an example of the lifting frame 712 limited to constant pitch arrays, the distance between clamps 716 is adjusted using a scissor arrangement.

In an example of adjusting the chain lengths so that the lifting frame 712 is level, each chain attaches to a powered and remotely controlled chain hoist 715 via a load cell. The load in each chain corresponding to a level lifting frame is determined for each array by calculation. By repeatedly cycling through each chain and incrementing length if the load is high and decrementing length if the load is low, the frame is brought into level. Instead of or additional to the above, the frame is adjusted using a level sensor. In an example, an increment is limited to no more than 10 millimetres.

The lifted array is moved 120 to a target location (i.e. the place where it will be cast within concrete) so that it is correctly in position and orientation.

Whilst still held by the lifting apparatus, the array is placed in the target location and means for holding 122 the rebar array in place are operated. That is, the individual bars of the rebar array are prevented from moving from an intended position.

In various example, arrays are picked up and moved by a lifting frame 712. At both ends of this operation the frame is accurately positioned, initially relative to the array, and finally relative to site datums. The efficiency and safety of the process is enhanced when one or more of the following features are additionally provided:

A means of guiding the lifting frame 410, 712 over an array layout bed such that lifting frame clamps 716 locate over their respective rebars. As the frame is lowered it first encounters coarse guidance. Further lowering and a fine guidance system engages. Coarse guidance is provided by a bumper 713 system which is configured to provide guidance in both X and Y dimensions. Fine guidance is provided by a tapered dowel 714. The configuration and location of the coarse guidance is such that a crane operator is able to position the lifting frame without needing additional assistance.

A means of guiding the lifting frame 712 so that the array of bars is released in the correct location. This is typically provided by movable bumpers 713 that capture the lifting frame 712. The bumpers 713 are located using conventional surveying techniques and secured in position. Where an array is being positioned parallel to another array, an additional feature is fitted to the lifting frame to maintain the correct spacing between the last bar of the previous array and the first bar of the array being placed.

The rebar array is then released 122 from the lifting apparatus and concrete is then cast over the rebar array.

An array is lowered so that the bars rest on rebar chairs or any underlying rebars. Before releasing the array from the lifting frame, it is necessary to ensure that the bars will not move when they are released. This may be achieved in one or more ways as now explained.

Each rebar, which will typically project from the lifting frame, is secured to transverse rebars in at least two places, those places being ideally spaced by approximately 70% of the rebar length. Securing is by wire tying, welding or any other suitable method.

Where rebars do not project beyond the lifting frame and tying is not possible, a chair is pre-fitted to the transverse rebar. When the array is lowered, the rebar should locate in the chair. The chair is designed to stop the rebar moving.

Combs are fitted into the lower rebar. The combs stop the rebar moving. The combs are subsequently cast into the concrete in some examples.

Once the rebars in the array have been secured, the clamps 716 are released and the lifting frame 712 removed. The lifting frame is adjusted, if necessary, in preparation for lifting the next array.

Examples of equipment used to construct rebar arrays in accordance with this invention are described herein by way of examples. The equipment is designed to either be directly transportable on the back of a lorry, or else rapidly assembled at site. In various example, the equipment is moveable within the construction site so that it is local to the area of mesh generation it is feeding. This greatly simplifies handling. In versions of the equipment where movability is provided, the equipment is also provided with the ability to be accurately levelled.

In some versions of the equipment, the array lifting frame is able to be lifted by a tele-handler. This decouples the equipment from a crane and reduces the number of times it is necessary to move the equipment so that it remains under crane cover.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A method of constructing an array of rebars, the method comprising:
automatically positioning a plurality of rebar such that they are spaced apart from one another to form an array;
using an array interval spacing means to maintain the spatial relationship of the rebar in the array;
releasing the array from the array interval spacing means such that the array is placed in a target location and orientation for casting into concrete;
removing the array interval spacing means.

2. The method of claim 1 wherein the array interval spacing means is any of: a rotary cassette, a bar cassette, or a plurality of clamps spaced at intervals on a lifting frame.

3-4. (canceled)

5. The method of claim 1 further comprising:
using a splitting apparatus to automatically split a single rebar from a bundle of rebars;
using automated moving means to move and position the single rebar into a location in the array;
repeating the use of the splitting apparatus and automated moving means for each rebar of the array.

6. The method of claim 5 where the automated moving means is any one or more of: a conveyor belt, a cassette loader.

7. The method of claim 5 wherein the splitting apparatus is a hopper and a means for lifting a base of the hopper in order to tip one of a plurality of rebar in the hopper over an edge of the hopper.

8. The method of claim 5 wherein the splitting apparatus has a rotary receiver to receive the rebar which tips over the edge of the hopper.

9. The method of claim 1 further comprising receiving the plurality of rebar into one or more receivers, each receiver configured to hold a plurality of rebar.

10. The method of claim 1 further comprising:
engaging the array interval spacing means with a lifting apparatus and using the lifting apparatus to move the array and the array interval spacing means to the target position and orientation.

11. The method of claim 10 further comprising:
activating holding means to hold the array in the target position and orientation;
releasing the array from the lifting apparatus.

12. The method of claim 6 wherein the automated moving means is a cassette loader and wherein the cassette is a rotary cassette, and wherein a bar riser is used to raise individual ones of the rebar towards a bar harvest mechanism which fills individual bars into the rotary cassette, and wherein the method comprises placing the rotary cassette onto a pair of drive bogies on pre-positioned rails, and driving the bogies along the rails via remote control, and using a remote control mechanism to release individual rebar from the cassette at intervals as the cassette is driver along the rails by the drive bogies.

13. The method of claim 1 comprising using a robot to perform one or more of the steps of the method.

14. The method of claim 13 wherein the cassette is configured to only release a rebar which is in a bottom dead centre of the cassette.

15. The method of claim 1 wherein the array interval spacing means is a bar cassette and the bar cassette comprises a plurality of hooks, each hook sized and shaped to hold a rebar, and where the hooks are rotatable between a first position in which rebar are held in the hooks and a second position where rebar roll out of the hooks and come to rest against an immediately preceding hook of the bar cassette.

16. The method of claim 15 comprising placing one rebar into each hook and lifting the bar cassette using an overhead crane and moving the bar cassette to the target position and orientation, and using a remote control to release the hooks to the second position.

17. The method of claim 1 comprising using a single apparatus having a splitting apparatus, array interval spacing means and automated moving means.

18. The method of claim 5 where the automated moving means is a conveyor belt having a deep pile surface configured to hold individual rebar in a fixed position.

19. The method of claim 5 comprising using a plurality of receivers, each receiver for a different type of rebar, and wherein the automated moving means comprises a first conveyor belt for conveying individual rebar from the plurality of receivers to a release gate which releases individual rebar onto a second conveyor belt such that the space between individual rebar on the second conveyor belt is controlled.

20. The method of claim 2 wherein the clamps are configured to not project below the underside of a rebar.

21. The method of claim 2 wherein the clamps are movable across the width of the lifting frame in order to align with rebars on the deep pile surface.

22. The method of claim 18 comprising using a bumper to generally align the frame over the deep pile surface and then using a dowel to finely align the frame over the deep pile surface.

23-25. (canceled)
